(19) United States
(12) Patent Application Publication
(10) Pub. No.: US 2025/0084652 A1
(43) Pub. Date: Mar. 13, 2025

(54) BUILDING CONSTRUCTION ROBOT

(71) Applicant: QINGDAO UNIVERSITY OF TECHNOLOGY, Linyi (CN)

(72) Inventors: Yang Li, Linyi (CN); Chengjun Chen, Linyi (CN); Xuefeng Zhang, Linyi (CN); Guangzheng Wang, Linyi (CN); Yongqi Wang, Linyi (CN); Liping Liang, Linyi (CN); Jianze Liu, Linyi (CN); Fazhan Yang, Linyi (CN); Fu'e Ren, Linyi (CN)

(73) Assignee: QINGDAO UNIVERSITY OF TECHNOLOGY, Linyi (CN)

(21) Appl. No.: 18/281,513

(22) PCT Filed: May 17, 2023
(86) PCT No.: PCT/CN23/94796

§ 371 Date: Sep. 11, 2023

(30) Foreign Application Priority Data
Feb. 10, 2023 (CN) 202310093655.7

(51) Int. Cl. E04G 21/04; E04F 21/24; E04G 21/08

(52) U.S. Cl. CPC E04G 21/04; E04F 21/242; E04G 21/08

(57) ABSTRACT

A building construction robot is provided. The building construction robot includes a vehicle body, a feeding assembly is arranged in the vehicle body, a mounting frame is fixedly connected to one end of the vehicle body, and the mounting frame is located at a discharge end close to the feeding assembly. One end of a vibrating assembly is fixedly connected to one end of a top of the vehicle body, and the other end of the vibrating assembly passes through a middle part of the mounting frame. A leveling assembly is arranged at one end, away from the vehicle body, of the mounting frame, a measuring part is arranged at a top of the mounting frame, and a moving part is arranged at a bottom of the vehicle body.

### CROSS-REFERENCE TO RELATED APPLICATION

This patent application is a national phase entry under 35 USC 371 of International Patent Application No. PCT/CN2023/094796, filed on May 17, 2023, which claims the priority to Chinese Patent Application No. 202310093655.7 filed with the China National Intellectual Property Administration on Feb. 10, 2023, the disclosure of which are incorporated by reference herein in their entirety as part of the present application.

### TECHNICAL FIELD

The present disclosure relates to the technical field of building construction, and in particular to a building construction robot.

### BACKGROUND

Building construction refers to production activities in the implementation stage of engineering construction, which is the construction process of various buildings. Building construction can also refer to the process of turning various lines on a design drawing into physical objects at specified locations, including foundation engineering construction, main structure construction, roof engineering construction, decoration engineering construction, etc.

With the development of science and technology, robot operation has replaced manual operation, which has the improved construction efficiency and quality.

In the existing floor construction process, steel bar erection, formwork erection and concrete pouring still need to be carried out manually. After the concrete pouring and vibrating, leveling robots are used to level the floor of the building. In the construction process, the main labor-consuming operation process still cannot be replaced by robots, and the leveling robots can only replace a small part of human operations, so a building construction robot is urgently needed to solve the problem.

### SUMMARY

An objective of the present disclosure is to provide a building construction robot to solve the above problems.

In order to achieve the above objective, the present disclosure provides the following solution.

A building construction robot, including a vehicle body, wherein a feeding assembly is arranged in the vehicle body, a mounting frame is fixedly connected to one end of the vehicle body, the mounting frame is located close to a discharge end of the feeding assembly, one end of a vibrating assembly is fixedly connected to one end of a top of the vehicle body, and an other end of the vibrating assembly passes through a middle part of the mounting frame; and a leveling assembly is arranged at one end, away from the vehicle body, of the mounting frame, a measuring part is arranged at a top of the mounting frame, and a moving part is arranged at a bottom of the vehicle body.

Preferably, the feeding assembly includes a feeding channel, the feeding channel is located in the vehicle body, a discharge port of the feeding channel is close to the mounting frame, a top of one end, away from the mounting frame, of the feeding channel communicates with a feeding pipe, and a transportation part is rotationally connected into the feeding channel.

Preferably, the transportation part includes a driving disk, the driving disk is located in the feeding channel, a side wall of the driving disk is in contact with an inner wall of the feeding channel and is arranged in a slidable manner, one end of a driving part is fixedly connected to an axis of one end of the driving disk, and an other end of the driving part is fixedly connected to a side wall of the vehicle body; and a hollow screw conveyor is fixedly connected to an other end of the driving disk, and the hollow screw conveyor is in fit with the feeding channel.

Preferably, the driving part includes a driving motor, an output shaft of the driving motor is coupled to a center of the driving disk, and a fixed end of the driving motor is fixedly connected to the side wall of the vehicle body.

Preferably, the vibrating assembly includes a rectangular upright rod, the rectangular upright rod is fixedly connected to one end of the top of the vehicle body, a sliding sleeve is sleeved on an outside of the rectangular upright rod in a vertically slidable manner, a rectangular cross rod is fixedly connected to an outer side wall of the sliding sleeve, and a reciprocating lifting part is sleeved outside of the rectangular cross rod in a horizontally slidable manner; a vibrating spear is rotationally connected to the reciprocating lifting part, the vibrating spear is vertically arranged, and the vibrating spear is located at the middle part of the mounting frame, a guide support is sleeved outside and connected to a middle part of the vibrating spear in a slidable manner, and the guide support is fixedly connected to one end of the top of the vehicle body; one end of a telescopic part is fixedly connected to a middle part of the rectangular cross rod, and an other end of the telescopic part is fixedly connected to the top of the vehicle body.

Preferably, the reciprocating lifting part includes a slider, the slider is sleeved an outside of the rectangular cross rod in a horizontally slidable manner, one side of the slider is provided with a chute, and the chute has a horizontally arranged isosceles triangular structure; a sliding shaft is connected into the chute in a slidable manner, a hinge shaft is arranged at an axis of the sliding shaft in a slidable manner, the hinge shaft is rotationally connected to the vibrating spear, a spring is arranged between the vibrating spear and the sliding shaft, the spring is sleeved outside the sliding shaft, and a reciprocating part is fixedly connected to a top of the slider.

Preferably, the reciprocating part includes a second rack, a bottom of the second rack is fixedly connected to the top of the slider, and a top of the second rack is meshed with two second gears symmetrically arranged; axes of the two second gears are rotationally connected to both ends of a gear connecting rod, one end of a second connecting rod is rotationally connected to a middle part of the gear connecting rod, an other end of the second connecting rod is rotationally connected to one end of a first rotating rod, and an output shaft of a third motor is fixedly connected to an other end of the first rotating rod; a bottom of the third motor is fixedly connected to a top of the rectangular cross rod; tops of the two second gears are meshed with a third rack, a fixed rod is fixedly connected to one end of the third rack, and a bottom of the fixed rod is fixedly connected to one end of the top of the rectangular cross rod.

Preferably, the leveling assembly includes two symmetrically arranged racks, the racks penetrate through and are arranged at both ends of the mounting frame in a slidable manner, the racks are meshed with gears, and axes of the two gears are fixedly connected to both ends of a biaxial motor; the biaxial motor is fixedly connected to the top of the mounting frame, a first connecting rod is fixedly connected to a bottom of each rack, ends, close to the vehicle body, of the two first connecting rods are fixedly connected to both ends of a strike-off plate, and a vibration plate is fixedly connected to ends, away from the vehicle body, of the two first connecting rods; a vibration motor is fixedly connected to a center of a top of the vibration plate, two inclined struts symmetrically arranged are fixedly connected to one end, away from the vehicle body, of the vibration plate, and end parts of the two inclined struts are fixedly connected to tops of the two racks, respectively.

Preferably, the measuring part includes two receiver mounting frames symmetrically arranged, the two receiver mounting frames are fixedly connected to both ends of the mounting frame respectively, and a laser measurement system is fixedly connected to a top of each of the two receiver mounting frames.

Preferably, the moving part includes four wheels, the four wheels are respectively arranged at a periphery of the vehicle body, and a motor is in transmission connection with a middle part of each of the four wheel.

The present disclosure has the following technical effects. When in use, the vehicle body is placed on a floor to be poured, concrete slurry is sent into the feeding assembly arranged in the vehicle body. Then, the vehicle body is controlled to move along a specified path by remote control or program, and the vehicle body is driven to move by the moving part. With the movement of the vehicle body, the concrete slurry is discharged from the discharge end of the feeding assembly to achieve floor pouring. Meanwhile, the vibrating assembly fixedly connected to one end of the top of the vehicle body vibrates the concrete slurry, such that the concrete is vibrated uniformly. The mounting frame fixedly connected to one end of the vehicle body drives the leveling assembly to trowel and level a vibrated concrete surface The measuring part arranged at the top of the mounting frame is used to measure the ground flatness in real time, so as to guarantee the uniformity of floor leveling. Concrete pouring, vibrating and trowelling processes can be achieved at one time, and the functions of the construction robot are enriched. The building construction robot does not require a great quantity of manpower during operation, and the production efficiency and quality are improved.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a building construction robot according to the present disclosure;

FIG. 2 is a structural schematic diagram of a reciprocating lifting part according to the present disclosure;

FIG. 3 is an exploded diagram of a structure at part A in FIG. 2 according to the present disclosure;

FIG. 4 is a cross-sectional schematic diagram taken along line B-B in FIG. 1 according to the present disclosure;

FIG. 5 is another structural schematic diagram of a building construction robot according to the present disclosure.

In the drawings: 1—vehicle body; 2—feeding channel; 3—driving motor; 4—driving disk; 5—hollow screw conveyor; 6—feeding pipe; 7—wheel; 8—vibrating spear; 9—strike-off plate; 10—first connecting rod; 11—vibration plate; 12—vibration motor; 13—inclined strut; 14—mounting frame; 15—biaxial motor; 16—gear; 17—rack; 18—receiver mounting frame; 19—laser measurement system; 20—rectangular upright pole; 21—sliding sleeve; 22—rectangular cross rod; 23—third motor; 24—first rotating rod; 25—second connecting rod; 26—telescopic rod; 27—guide support; 28—slider; 29—second rack; 30—gear connecting rod; 31—second gear; 32—third rack; 33—fixed rod; 34—hinge shaft; 35—chute; 36—sliding shaft; 37—spring; 38—frame; 39—slide rail; 40—sliding block; 41—fourth motor; 42—beam; 43—lead screw; 44—threaded block; 45—electric hoist; 46—steel cable.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the above objectives, features and advantages of the present disclosure more apparently and understandably, the present disclosure is further described in detail below with reference to the accompanying drawings and specific embodiments.

### Embodiment I

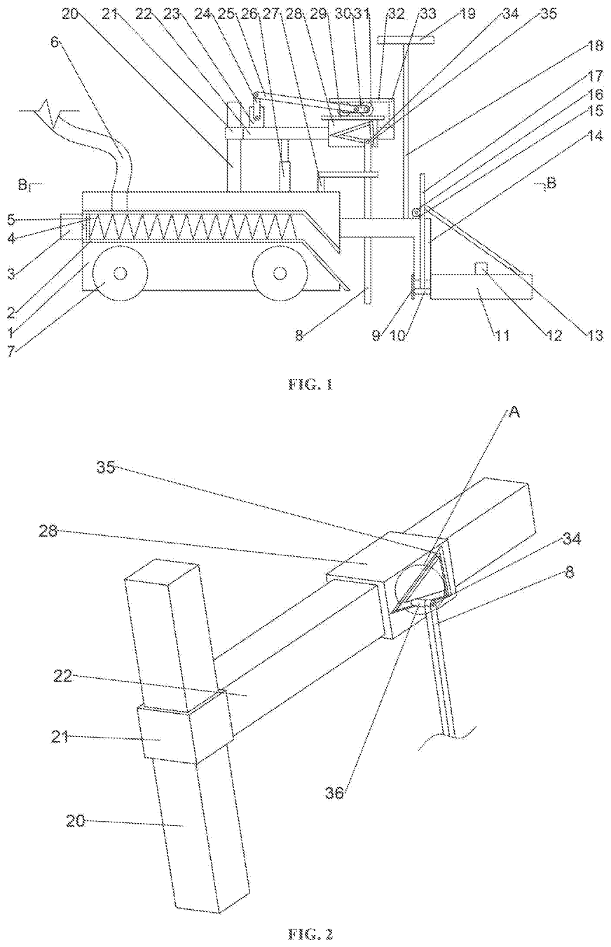

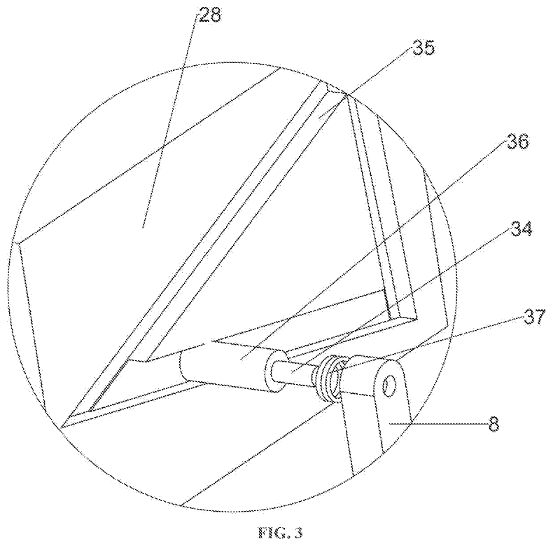

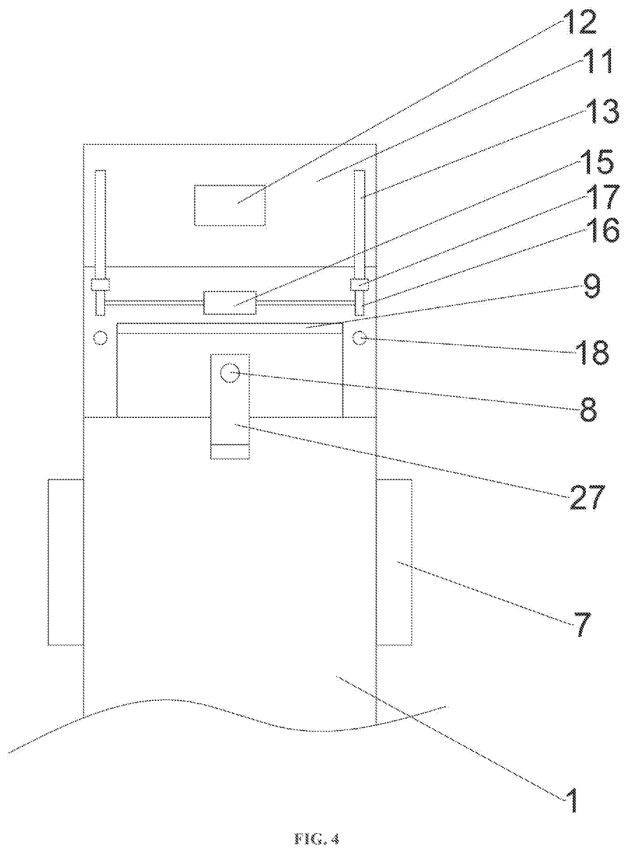

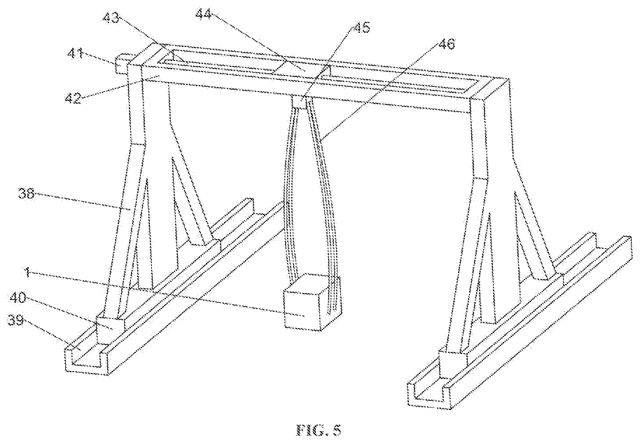

Referring to FIG. 1, FIG. 2, FIG. 3 and FIG. 4, it is provided a building construction robot according to this embodiment, including a vehicle body 1. A feeding assembly is arranged in the vehicle body 1, and a mounting frame 14 is fixedly connected to one end of the vehicle body 1. The mounting frame 14 is located close to a discharge end of the feeding assembly. One end of a vibrating assembly is fixedly connected to one end of a top of the vehicle body 1, and the other end of the vibrating assembly passes through a middle part of the mounting frame 14. A leveling assembly is arranged at one end, away from the vehicle body 1, of the mounting frame 14, a measuring part is arranged at a top of the mounting frame 14, and a moving part is arranged at a bottom of the vehicle body 1.

When in use, the vehicle body 1 is placed on a floor to be poured, concrete slurry is sent into the feeding assembly arranged in the vehicle body 1. Then, the vehicle body 1 is controlled to move along a specified path by remote control or program, and the vehicle body 1 is driven to move by the moving part. With the movement of the vehicle body 1, the concrete slurry is discharged from the discharge end of the feeding assembly to achieve floor pouring. Meanwhile, the vibrating assembly fixedly connected to one end of the top of the vehicle body 1 vibrates the concrete slurry, such that the concrete is vibrated uniformly. The mounting frame 14 fixedly connected to one end of the vehicle body 1 drives the leveling assembly to trowel and level a vibrated concrete surface. The measuring part arranged at the top of the mounting frame 14 is used to measure the ground flatness in real time, so as to guarantee the uniformity of floor leveling. Concrete pouring, vibrating and trowelling processes can be achieved at one time, and the functions of the construction robot are enriched. The building construction robot does not require a great quantity of manpower during operation, and the production efficiency and quality are improved.

According to a further optimization scheme, the feeding assembly includes a feeding channel 2. The feeding channel 2 is located in the vehicle body 1, a discharge port of the feeding channel 2 is close to the mounting frame 14, a top of one end, away from the mounting frame 14, of the feeding channel 2 communicates with a feeding pipe 6, and a transportation part is rotationally connected into the feeding channel 2.

According to a further optimization scheme, the transportation part includes a driving disk 4. The driving disk 4 is located in the feeding channel 2, a side wall of the driving disk 4 is in contact with an inner wall of the feeding channel 2 and is arranged in a slidable manner. One end of a driving part is fixedly connected to an axis of one end of the driving disk 4, and the other end of the driving part is fixedly connected to a side wall of the vehicle body 1. A hollow screw conveyor 5 is fixedly connected to the other end of the driving disk 4, and the hollow screw conveyor 5 is in fit with the feeding channel 2.

According to a further optimization scheme, the driving part includes a driving motor 3. An output shaft of the driving motor 3 is coupled to the center of the driving disk 4, and a fixed end of the driving motor 3 is fixedly connected to the side wall of the vehicle body 1.

One end of the feeding pipe 6 communicates with a concrete pumping machine, and the other end of the feeding pipe 6 is located at the top of the vehicle body 1 and communicates with one end of the top of the feeding channel 2, so as to convey concrete slurry into the feeding channel 2.

The hollow screw conveyor 5 is arranged inside the feeding channel 2, the concrete falling into the feeding channel 2 moves towards the discharge end of the feeding channel 2 along the hollow screw conveyor 5, an axis of the hollow screw conveyor 5 is of a hollow structure to facilitate the passage of the concrete. As shown in FIG. 1, a conveying direction of the hollow screw conveyor 5 is from left to right, and an outer diameter of the hollow screw conveyor 5 is in fit with an inner diameter of the feeding channel 2. One end of the hollow screw conveyor 5 is fixedly connected to the driving disk 4, and an output shaft of the driving motor 3 penetrates through the side wall of the vehicle body 1 and is fixedly connected to the axis of the driving disk 4. When the driving motor 3 drives the driving disk 4 to rotate, the driving disk 4 drives the hollow screw conveyor 5 to rotate, so as to achieve the conveying of the concrete slurry.

As the concrete slurry is prone to be solidified, the concrete slurry is stirred simultaneously when being conveyed through the hollow screw conveyor 5, thereby preventing the concrete slurry from being solidified in the feeding channel 2.

According to a further optimization scheme, the vibrating assembly includes a rectangular upright rod 20. The rectangular upright rod 20 is fixedly connected to one end of the top of the vehicle body 1, and a sliding sleeve 21 is sleeved on an outside of the rectangular upright rod 20 in a vertically slidable manner. A rectangular cross rod 22 is fixedly connected to an outer side wall of the sliding sleeve 21, and a reciprocating lifting part is sleeved on an outside of the rectangular cross rod 22 in a horizontally slidable manner. A vibrating spear 8 is rotationally connected to the reciprocating lifting part, the vibrating spear 8 is vertically arranged, and the vibrating spear 8 is located at the middle part of the mounting frame 14. A guide support 27 is sleeved outside and connected to a middle part of the vibrating spear 8 in a slidable manner, and the guide support 27 is fixedly connected to one end of the top of the vehicle body 1. One end of a telescopic part is fixedly connected to a middle part of the rectangular cross rod 22, and the other end of the telescopic part is fixedly connected to the top of the vehicle body 1.

The rectangular cross rod 22 is driven by a telescopic part to move up and down, such that the sliding sleeve 21 at the end part of the rectangular cross rod 22 slides outside the rectangular upright rod 20 to drive the reciprocating lifting part and the vibrating spear 8, which is rotationally connected to the reciprocating lifting part, to move up and down. The vibrating spear 8 is arranged vertically, and the guide support 27 which is sleeved outside and connected to the middle part of the vibrating spear 8 in a slidable manner can keep the vibrating spear 8 vertical, so as to ensure that the vibrating spear 8 can be vertically inserted into the concrete when the reciprocating lifting part drives the vibrating spear 8 to vibrate. The telescopic part can change a height of a bottom of the vibrating spear 8, thus ensuring that the vibrating can be started from the bottom of the concrete slurry.

According to a further optimization scheme, the reciprocating lifting part includes a slider 28. The slider 28 is sleeved on an outside of the rectangular cross rod 22 in a horizontally slidable manner, one side of the slider 28 is provided with a chute 35, and the chute 35 is a horizontally arranged isosceles triangular structure. A sliding shaft 36 is connected into the chute 35 in a slidable manner, a hinge shaft 34 is arranged at an axis of the sliding shaft 36 in a slidable manner, and the hinge shaft 34 is rotationally connected to the vibrating spear 8. A spring 37 is arranged between the vibrating spear 8 and the sliding shaft 36, the spring 37 is sleeved outside the sliding shaft 36, and a reciprocating part is fixedly connected to a top of the slider 28.

As shown in FIG. 1, the chute 35 is an isosceles triangular structure horizontally arranged, and the sliding shaft 36 slides in the chute 35. As shown in FIG. 3, each edge of the chute 35 is provided with a slope, and the edges are connected end to end in turn from low to high, and the joint of the edges is also provided with a step structure, which can prevent the sliding shaft 36 from sliding reversely when the sliding shaft 36 slides along each edge of the chute 35.

The hinge shaft 34 is arranged at the axis of the sliding shaft 36 in a slidable manner, the hinge shaft 34 is rotationally connected to the vibrating spear 8, and a spring 37 is arranged between the vibrating spear 8 and the sliding shaft 36. Because the middle part of the vibrating spear 8 is connected to the guide support 27 in a slidable manner, the guide support 27 restricts the movement of the vibrating spear 8 in other directions while restricting a vertical displacement of the vibrating spear 8, such that the sliding shaft 36 may slide along the binge shaft 34 when sliding along a ramp of each edge of the chute 35. An initial state of the spring 37 is a compressed state, and a bottom of the sliding shaft 36 is always attached closely to a side wall of the chute 35 through the spring 37, thereby preventing the sliding shaft 36 from slipping off the chute 35.

When in use, after the height of a bottom of the vibrating spear 8 is adjusted by a telescopic rod 26, the vibrating spear 8 is completely immersed into the concrete. The sliding shaft 36 moves along a waist edge of the isosceles triangle of the chute 35 at first. As the slope of the waist edge of the chute 35 is small, the vibrating spear 8 is slowly raised along with the movement of the sliding shaft 36 to simulate a slow pulling process of the vibrating spear 8 during manual vibrating. When the sliding shaft 36 slides to a bottom edge of the isosceles triangle structure of the chute 35, the vibrating spear 8 falls rapidly due to the large slope of the bottom edge to simulate a fast insertion process of the vibrating spear 8 during manual vibrating, thus ensuring the requirements of fast insertion, slow pulling and vertical insertion of the vibrating spear 8 during concrete vibrating.

According to a further optimization scheme, the reciprocating part includes a second rack 29. A bottom of the second rack 29 is fixedly connected to the top of the slider 28, and a top of the second rack 29 is meshed with two second gears 31 symmetrically arranged. Axes of the two second gears 31 are rotationally connected to both ends of a gear connecting rod 30, one end of a second connecting rod 25 is rotationally connected to a middle part of the gear connecting rod 30, the other end of the second connecting rod 25 is rotationally connected to one end of a first rotating rod 24, and an output shaft of a third motor 23 is fixedly connected to the other end of the first rotating rod 24. A bottom of the third motor 23 is fixedly connected to a top of the rectangular cross rod 22. Tops of the two second gears 31 are meshed with a third rack 32, a fixed rod 33 is fixedly connected to one end of the third rack 32, and a bottom of the fixed rod 33 is fixedly connected to one end of the top of the rectangular cross rod 22.

The first rotating rod 24 is driven by an output shaft of the third motor 23 to rotate, an end part of the first rotating rod 24 drives one end of the second connecting rod 25 to rotate, such that one end of the second connecting rod 25 drives a gear connecting rod 30 to slide repeatedly between the third rack 32 and the second rack 29. The second gears 31 are rotationally connected to both ends of the gear connecting rod 30, respectively. An edge of each second gear 31 is meshed with the third rack 32 and the second rack 29, respectively. The third rack 32 is fixedly connected to the rectangular cross rod 22 by the fixed rod 33. When the gear connecting rod 30 drives the two second gears 31 to move horizontally, the third rack 32 enables the second gears 32 to rotate, and the second gears 31 rotate to drive the second rack 29 to move, thus achieving the reciprocation of the slider 28.

Compared to the traditional mode of achieving reciprocating motion through the telescopic rod or directly through a crankshaft, based on that a length of an arc edge of the second gear 31 is greater than a horizontal displacement, the second rack 29 is driven to move through the rotation of the second gear 31, thus the horizontal movement range of the second rack 29 is greatly increased, which in turn can achieve the reduction of the volume of the equipment.

According to a further optimization scheme, the leveling assembly includes two racks 17 symmetrically arranged. The racks 17 penetrate through and are arranged at both ends of the mounting frame 14 in a slidable manner, the racks 17 are meshed with gears 16, and axes of the two gears 16 are fixedly connected to both ends of a biaxial motor 15. The biaxial motor 15 is fixedly connected to the top of the mounting frame 14, and a first connecting rod 10 is fixedly connected to a bottom of each rack 17. Ends, close to the vehicle body 1, of the two first connecting rods 10 are fixedly connected to both ends of a strike-off plate 9, and a vibration plate 11 is fixedly connected to ends, away from the vehicle body 1, of the two first connecting rods 10. A vibration motor 12 is fixedly connected to the center of a top of the vibration plate 11. Two inclined struts 13 symmetrically arranged are fixedly connected to one end, away from the vehicle body 1, of the vibration plate 11, and end parts of the two inclined struts 13 are fixedly connected to tops of the two racks 17, respectively.

As shown in FIG. 4, the biaxial motor 15 is used to drive the gears 16 at both ends to rotate, and in turn to drive the racks 17 meshed with the gears 16 to move up and down at the same time, thereby changing heights of both the strike-off plate 9 and the vibration plate 11. The heights of both the strike-off plate 9 and the vibration plates 11 are adjusted according to the real-time measurement data of the measuring part, thereby ensuring the level of a laid plate surface, greatly reducing errors and ensuring flatness.

The strike-off plate 9 is used to screed the concrete surface with the movement of the vehicle body 1, and then the vibration motor 12 drives the vibration plate 11 to vibrate the concrete surface, so as to further discharge bubbles on the concrete surface, and make the concrete surface more compact and less prone to cracks.

A bottom of the strike-off plate 9 and a bottom of the vibration plate 11 are on the same horizontal plane, and the strike-off plate 9 and the vibration plate 11 are connected by a first connecting rod 10. And, a top middle part of the first connecting rod 10 is fixedly connected to the bottom of the rack 17, and then the strike-off plate 9 and the vibration plate 11 can be lifted and lowered simultaneously through the up-down movement of the rack 17.

As shown in FIG. 1, one end, away from the strike-off plate 9, of the vibration plate 11 is also fixedly connected to one end of an inclined strut 13 obliquely arranged, and the other end of the inclined strut 13 is fixedly connected to the top of the rack 17, so as to ensure that left and right ends of the vibration plate 11 can be lifted and lowered simultaneously when the rack 17 is lifted and lowered.

According to a further optimization scheme, the measurement part includes two receiver mounting frames 18 symmetrically arranged, the receiver mounting frames 18 are fixedly connected to both ends of the mounting frame 14, and a laser measurement system 19 is fixedly connected to a top of each receiver mounting frame 18.

The top end of each of the two receiver mounting frames 18 is fixedly provided with the laser measurement system 19. The laser measurement system includes sensors, such as an electronic level, a laser gyroscope, and a laser receiver, all of which are in signal connection with a laser measurement and control system. And, the laser measurement and control system is in signal connection with a computer control system. The electronic level and the laser gyroscope emit laser to measure a relative horizontal plane and angle information. After receiving a signal, a laser receiver feeds back the signal to the laser measurement and control system for analysis, the analyzed deviation data is fed back to the computer control system, and the computer control system makes a corresponding instruction accordingly.

According to a further optimization scheme, the moving part includes four wheels 7. The four wheels 7 are respectively arranged at the periphery of the vehicle body 1, and a motor (not shown in figure) is in transmission connection with a middle part of each wheel 7.

Each of the four wheels 7 is in transmission connection with the motor (not shown in the figure), and the steering as well as the forward and backward movement of the vehicle body 1 can be controlled by controlling the rotational speed of different motors.

The wheel 7 in this embodiment is preferably a vacuum rubber tire.

The wheel 7 may preferably be a Mecanum wheel, and the four Wheels 7 are in fit with each other. The Mecanum wheel can enrich the movement mode of the vehicle body 1, thus achieving the actions such as a lateral movement and a pivot steering of the vehicle body 1.

The operating process of this embodiment is as follows: When in use, the vehicle body 1 is placed on a floor to be poured, one end of the feeding pipe 6 communicates with a concrete pumping machine, and the other end of the feeding pipe 6 communicates with one end of the top of the feeding channel 2. Then, the concrete slurry is conveyed into the feeding channel 2. The driving motor 3 drives the driving disk 4 to rotate and in turn drives the hollow screw conveyor 5 to rotate, so as to convey the concrete slurry to the discharge end of the feeding channel 2 to achieve pouring.

After the height of the bottom of the vibrating spear 8 is adjusted in advance through the telescopic rod 26, the vibrating spear 8 is completely immersed into the concrete during pouring. Then, the first rotating rod 24 is driven by an output shaft of the third motor 23 to rotate, and an end part of the first rotating rod 24 drives one end of the second connecting rod 25 to rotate. In this way, one end of the second connecting rod 25 drives a gear connecting rod 30 to slide repeatedly between the third rack 32 and the second rack 29. The second gears 31 are rotationally connected to both ends of the gear connecting rod 30, respectively. An edge of each gear 31 is meshed with the third rack 32 and the second rack 29, respectively. The third rack 32 is fixedly connected to the rectangular cross rod 22 by the fixed rod 33. When the gear connecting rod 30 drives the two second gears 31 to move horizontally, the third rack 32 enables the second gear 32 to rotate, and the second gear 31 rotates to drive the second rack 29 to move, thus achieving the reciprocation of the slider 28.

The reciprocation of the slider 28 enables the sliding shaft 36 to move along a waist edge of the isosceles triangle of the chute 35 at first. As the slope of the waist edge of the chute 35 is small, the vibrating spear 8 is slowly raised along with the movement of the sliding shaft 36 to simulate a slow pulling process of the vibrating spear 8 during manual vibrating. When the sliding shaft 36 slides to a bottom edge of the isosceles triangle structure of the chute 35, the vibrating spear 8 falls rapidly due to the large slope of the bottom edge to simulate the fast insertion process of the vibrating spear 8 during manual vibrating, thus ensuring the requirements of fast insertion, slow pulling and vertical insertion of the vibrating spear 8 during concrete vibrating.

Laser measurement systems 19 fixedly arranged at the top ends of the two receiver mounting frames 18 are used to measure the ground flatness and obtain information. The biaxial motor 15 is used to drive the gears 16 at both ends to rotate, and then to drive the racks 17 meshed with the gears 16 to move up and down at the same time, so as to adjust the horizontal heights of both the bottom of the strike-off plate 9 and the bottom of the vibration plate 11. After the pouring and vibrating are completed, the concrete surface is stricken off and vibrated along with the movement of the vehicle body 1.

The vehicle body 1 is controlled to move along a specified path by remote control or program, and the vehicle body 1 is driven by the four wheels 7 to move. With the movement of the vehicle body 1, concrete pouring, vibrating and trowelling processes can be achieved at one time, and the functions of the construction robot are enriched. The building construction robot does not require a greater quantity of manpower during operation, and the production efficiency and quality are improved

### Embodiment II

Referring to FIG. 5, the difference between this embodiment and Embodiment I is only that the periphery of the vehicle body 1 is connected to an electric hoist 45 through steel cables 46, a top of the electric hoist 45 is fixedly connected to a bottom of a threaded block 44, a beam 42 is connected to an outer wall of the threaded block 44 in a slidable manner, a lead screw 43 is rotationally connected to a middle part of the beam 42, and the lead screw 43 is threaded to the threaded block 44. Frames 38 are fixedly connected to both ends of the beam 42, the center of any end of the lead screw 43 is coupled to an output end of a fourth motor 41, and a fixed end of the fourth motor 41 is fixedly connected to a side wall of the frame 38. A sliding block 40 is fixedly connected to a bottom of the frame 38, and the sliding block 40 is connected to a slide rail 39 in a slidable manner.

Driving motors (not shown in the figure) and driving wheels (not shown in the figure) are fixedly connected to both ends of the sliding block 40, and the drive motors and the drive wheels push the slider 40 to slide in the slide rail 39, thereby driving the frame 38 to move.

Usually, steel bars on a top roof panel of a house are arranged in double layers and two directions. The steel bars on an upper layer are pressed by the vehicle body 1, such that a spacing between the two layers of steel bars of the roof panel is closer, thus affecting the quality of the roof panel. Therefore, during the construction of the roof panel, the slide rails 39 can be arranged on both sides of a roof, and the vehicle body 1 can be hoisted by the steel cables 46 through the frames 38, the beam 42, the threaded block 44 on the beam 42, and the electric hoist 45. A sliding direction of the threaded block 44 is perpendicular to a sliding direction of the sliding block 40 on the slide rail 39.

A height of the vehicle body 1 is controlled by the electric hoist 45 and the steel cables 46, and the fourth motor 41 is used to drive the lead screw 43 to rotate, thus making the threaded block 44 slide and making the sliding block 40 slide on the slide rail 39 to achieve the movement in X and Y directions.

Thereby, the vehicle body 1 is prevented from directly pressing against the steel bar layer of the roof surface, so as to improve the quality of the roof panel.

In the description of the present disclosure, it should be understood that the orientation or positional relationship indicated by terms “longitudinal”, “transverse”, “upper”, “lower”, “front”, “rear”, “left”, “right”, “vertical”, “horizontal”, “top”, “bottom”, “inside”, “outside” is based on the orientation or positional relationship shown in the drawings only for convenience of description of the present disclosure rather than indicating or implying that the device or element referred to must have a particular orientation, be constructed and operate in a particular orientation, and thus are not to be construed as limiting the present disclosure.

The above embodiments are only a description of the preferred mode of the present disclosure, rather than limiting the scope of the present disclosure. Various deformations and improvements made to the technical solutions of the present disclosure by those of ordinary skill in the art without departing from the spirit of the design of the present disclosure shall fall within the scope of protection determined by the present disclosure.

What is claimed is:

1. A building construction robot, comprising a vehicle body (1), wherein a feeding assembly is arranged in the vehicle body (1), a mounting frame (14) is fixedly connected to one end of the vehicle body (1), the mounting frame (14) is located close to a discharge end of the feeding assembly, one end of a vibrating assembly is fixedly connected to one end of a top of the vehicle body (1), and an other end of the vibrating assembly passes through a middle part of the mounting frame (14); and a leveling assembly is arranged at one end, away from the vehicle body (1), of the mounting frame (14), a measuring part is arranged at a top of the mounting frame (14), and a moving part is arranged at a bottom of the vehicle body (1).

2. The building construction robot according to claim 1, wherein the feeding assembly comprises a feeding channel (2), the feeding channel (2) is located in the vehicle body (1), a discharge port of the feeding channel (2) is close to the mounting frame (14), a top of one end, away from the mounting frame (14), of the feeding channel (2) communicates with a feeding pipe (6), and a transportation part is rotationally connected into the feeding channel (2).

3. The building construction robot according to claim 2, wherein the transportation part comprises a driving disk (4), the driving disk (4) is located in the feeding channel (2), a side wall of the driving disk (4) is in contact with an inner wall of the feeding channel (2) and is arranged in a slidable manner, one end of a driving part is fixedly connected to an axis of one end of the driving disk (4), and an other end of the driving part is fixedly connected to a side wall of the vehicle body (1); and a hollow screw conveyor (5) is fixedly connected to an other end of the driving disk (4), and the hollow screw conveyor (5) is in fit with the feeding channel (2).

4. The building construction robot according to claim 3, wherein the driving part comprises a driving motor (3), an output shaft of the driving motor (3) is coupled to a center of the driving disk (4), and a fixed end of the driving motor (3) is fixedly connected to the side wall of the vehicle body (1).

5. The building construction robot according to claim 1, wherein the vibrating assembly comprises a rectangular upright rod (20), the rectangular upright rod (20) is fixedly connected to one end of the top of the vehicle body (1), a sliding sleeve (21) is sleeved on an outside of the rectangular upright rod (20) in a vertically slidable manner, a rectangular cross rod (22) is fixedly connected to an outer side wall of the sliding sleeve (21), and a reciprocating lifting part is sleeved outside of the rectangular cross rod (22) in a horizontally slidable manner; a vibrating spear (8) is rotationally connected to the reciprocating lifting part, the vibrating spear (8) is vertically arranged, and the vibrating spear (8) is located at the middle part of the mounting frame (14); a guide support (27) is sleeved outside and connected to a middle part of the vibrating spear (8) in a slidable manner, and the guide support (27) is fixedly connected to one end of the top of the vehicle body (1); one end of a telescopic part is fixedly connected to a middle part of the rectangular cross rod (22), and an other end of the telescopic part is fixedly connected to the top of the vehicle body (1).

6. The building construction robot according to claim 5, wherein the reciprocating lifting part comprises a slider (28), the slider (28) is sleeved an outside of the rectangular cross rod (22) in a horizontally slidable manner, one side of the slider (28) is provided with a chute (35), and the chute (35) has a horizontally arranged isosceles triangular structure; a sliding shaft (36) is connected into the chute (35) in a slidable manner, a hinge shaft (34) is arranged at an axis of the sliding shaft in a slidable manner, the hinge shaft (34) is rotationally connected to the vibrating spear (8), a spring (37) is arranged between the vibrating spear (8) and the sliding shaft (36), the spring (37) is sleeved outside the sliding shaft (36), and a reciprocating part is fixedly connected to a top of the slider (28).

7. The building construction robot according to claim 6, wherein the reciprocating part comprises a second rack (29), a bottom of the second rack (29) is fixedly connected to the top of the slider (28), and a top of the second rack (29) is meshed with two second gears (31) symmetrically arranged; axes of the two second gears (31) are rotationally connected to both ends of a gear connecting rod (30), one end of a second connecting rod (25) is rotationally connected to a middle part of the gear connecting rod (30), an other end of the second connecting rod (25) is rotationally connected to one end of a first rotating rod (24), and an output shaft of a third motor (23) is fixedly connected to an other end of the first rotating rod (24); a bottom of the third motor (23) is fixedly connected to a top of the rectangular cross rod (22); tops of the two second gears (31) are meshed with a third rack (32), a fixed rod (33) is fixedly connected to one end of the third rack (32), and a bottom of the fixed rod (33) is fixedly connected to one end of the top of the rectangular cross rod (22).

8. The building construction robot according to claim 1, wherein the leveling assembly comprises two symmetrically arranged racks (17), the racks (17) penetrate through and are arranged at both ends of the mounting frame (14) in a slidable manner, the racks (17) are meshed with gears (16), and axes of the two gears (16) are fixedly connected to both ends of a biaxial motor (15); the biaxial motor (15) is fixedly connected to the top of the mounting frame (14), a first connecting rod (10) is fixedly connected to a bottom of each rack (17), ends, close to the vehicle body (1), of the two first connecting rods (10) are fixedly connected to both ends of a strike-off plate (9), and a vibration plate (11) is fixedly connected to ends, away from the vehicle body (1), of the two first connecting rods (10); a vibration motor (12) is fixedly connected to a center of a top of the vibration plate (11), two inclined struts (13) symmetrically arranged are fixedly connected to one end, away from the vehicle body (1), of the vibration plate (11), and end parts of the two inclined struts (13) are fixedly connected to tops of the two racks (17), respectively.

9. The building construction robot according to claim 1, wherein the measuring part comprises two receiver mounting frames (18) symmetrically arranged, the two receiver mounting frames (18) are fixedly connected to both ends of the mounting frame (14) respectively, and a laser measurement system (19) is fixedly connected to a top of each of the two receiver mounting frames (18).

10. The building construction robot according to claim 1, wherein the moving part comprises four wheels (7), the four wheels (7) are respectively arranged at a periphery of the vehicle body (1), and a motor is in transmission connection with a middle part of each of the four wheel (7).
